(19) United States
(12) Patent Application Publication
(10) Pub. No.: US 2009/0259957 A1
(43) Pub. Date: Oct. 15, 2009

(54) CONFIGURABLE ICONS FOR CONTENT PRESENTATION

(75) Inventors: Tyler J. Slocum, Encino, CA (US); Eric J. Bennett, Los Angeles, CA (US); Jon M. Dean, Torrance, CA (US); Brady C. Tsurutani, Sherman Oaks, CA (US); Don E. Cansino, Brea, CA (US)

Correspondence Address: THE DIRECTV GROUP, INC.;PATENT DOCKET ADMINISTRATION, CA / LA1 / A109, 2230 E. IMPERIAL HIGHWAY, EL SEGUNDO, CA, 90245, US

(73) Assignee: The DIRECTV Group, Inc., El Segundo, CA (US)

(21) Appl. No.: 12/419,894

(22) Filed: Apr. 7, 2009

Related U.S. Application Data
(60) Provisional application No. 61/043,488, filed on Apr. 9, 2008.

(51) Int. Cl. G06F 3/048

(52) U.S. Cl. 715/765; 709/231

(57) ABSTRACT

Overlay applications for use in a media presentation system are described. An example method for use with broadcast media includes maintaining a collection of overlay applications to be displayed in connection with the broadcast media; enabling a user to select and configure one or more of the overlay applications for presentation on a media presentation system; executing one or more selected overlay applications to display periodically updated information associated with the overlay applications.

### FIELD OF THE DISCLOSURE

The present disclosure relates generally to media presentation systems and, more particularly, to the use of configurable icons for content presentation.

### BACKGROUND

Satellite television delivery systems, and other media presentation systems, have become commonplace. Such systems typically include a user interface, usually controlled through a remote control, to assist a user in searching through available content, manipulating features of the media presentation system, or ordering programs for pay-per-view or download.

Typically, the user interface is implemented in a series of menus, lists, and/or guides that are presented on the monitor of such a system. The elements of the user interface may indicate what programs, movies, music, or other events are scheduled for broadcast at certain times, which programs are scheduled for downloading, the contents of a queue, etc. The user may manipulate such a guide to determine upcoming or current programming by moving a cursor through the guide via a remote control or another similar input device. Further, elements of the guide may be selected to tune to programs or events, where the user may determine the status (e.g., a sports score, the weather, a stock price, etc.) of the program or a related event from the broadcast program itself (e.g., determining a sports score by listening to an announcer). Such a status may not be immediately obtainable if, for example, the broadcast program is at commercial.

Other interfaces are also available, such as interfacing with the system via the internet and controlling a receiver, recorder, or other device using a computer. Scheduling of shows recording of programs, and other actions can be taken via the computer interface as well as via the remote control.

Since the programming choices have become more complex, users expect to see additional features for content delivery.

### SUMMARY OF THE INVENTION

To minimize the limitations in the prior art, and to minimize other limitations that will become apparent upon reading and understanding the present specification, the present invention discloses methods, apparatuses, and systems for using overlay applications within a broadcast communications system.

A method of using overlay applications within a broadcast communications system in accordance with one or more embodiments of the present invention comprises collecting data from a plurality of sources, generating a plurality of overlay applications from the data, selecting an overlay application from the plurality of overlay applications for display on a monitor, and selectively displaying the selected overlay application on the monitor simultaneously with a broadcast data stream.

Such a method further optionally comprises updating the selected overlay application prior to selectively displaying the selected overlay application, updating the selected overlay application comprises streaming data to the selected overlay application, determining a location on the monitor for display of the selected overlay application, storing at least a subset of the plurality of overlay applications at a set-top box, and creating a custom overlay application, and including the custom overlay application in the plurality of overlay applications.

An apparatus for displaying a broadcast data stream and a user-selected overlay application on a monitor in a broadcast communications system, in accordance with one or more embodiments of the present invention comprises a receiver, an overlay application controller, coupled to the receiver, a storage device, coupled to the overlay application controller and the receiver, a network interface, coupled to the controller and the receiver, and a user interface, coupled to the controller, wherein at least one overlay application is selected via the user interface, received at the receiver, stored in the storage device, and selectively displayed simultaneously with the broadcast data stream on the monitor.

Such an apparatus further optionally comprises the at least one overlay application being received at the receiver via the network interface, the at least one overlay application being received at the receiver via the broadcast communications system, the broadcast communications system being a satellite broadcast system, updating the overlay application when the overlay application is selectively displayed on the monitor, updating the overlay application comprising streaming data to the overlay application, determining a location on the monitor for display of the overlay application via the user interface, and creating a custom overlay application via the user interface.

A system for displaying a broadcast data stream and a user-selected overlay application on a monitor in a broadcast communications system in accordance with one or more embodiments of the present invention comprises a transmission system for transmitting a plurality of broadcast data streams and for transmitting and generating a plurality of overlay applications, a receiver for receiving the plurality of broadcast data streams and the plurality of overlay applications, an overlay application controller, coupled to the receiver, for executing the plurality of overlay applications, and a user interface, coupled to the receiver, for selecting the user-selected overlay application from the plurality of overlay applications, wherein the user-selected overlay application is displayed on the monitor simultaneously with the broadcast data stream.

Such a system further optionally comprises a network interface, coupled to the receiver, wherein the network interface further receives the plurality of overlay applications from the transmission system, a memory, coupled to the receiver and the network interface, wherein the user-selected overlay application is stored in the memory, the transmission system being a satellite broadcast system, the user-selected overlay application being customized via the user interface, and the user-selected overlay application being created via the user interface.

Other features and advantages are inherent in the system disclosed or will become apparent to those skilled in the art from the following detailed description and its accompanying drawings.

### BRIEF DESCRIPTION OF THE DRAWINGS

FIG. 1 is a diagram of an example direct-to-home (DTH) transmission and reception system.

FIG. 2 illustrates an embodiment in accordance with one or more embodiments of implementing an integrated receiver/decoder (IRD) of FIG. 1 with the present invention.

FIG. 3 is a flowchart in accordance with one or more embodiments of the present invention representing an example process that may be performed by a media presentation system implementing an example overlay feature.

FIGS. 4A-F show example screenshots of a media presentation system implementing the example process of FIG. 3 in one or more embodiments of the present invention.

FIGS. 5A and 5B show example screenshots including example overlays as displayed by example overlay applications in accordance with one or more embodiments of the present invention.

FIG. 6 shows an example screenshot including an example overlay list in accordance with one or more embodiments of the present invention.

FIG. 7 is a flowchart representing an example process that may be performed by a media presentation system implementing an example overlay feature in accordance with one or more embodiments of the present invention.

FIG. 8 illustrates an example manner of implementing an example processor unit to execute the example methods and apparatus described herein in accordance with one or more embodiments of the present invention.

FIG. 9 is a process chart in accordance with one or more embodiments of the present invention.

### DETAILED DESCRIPTION

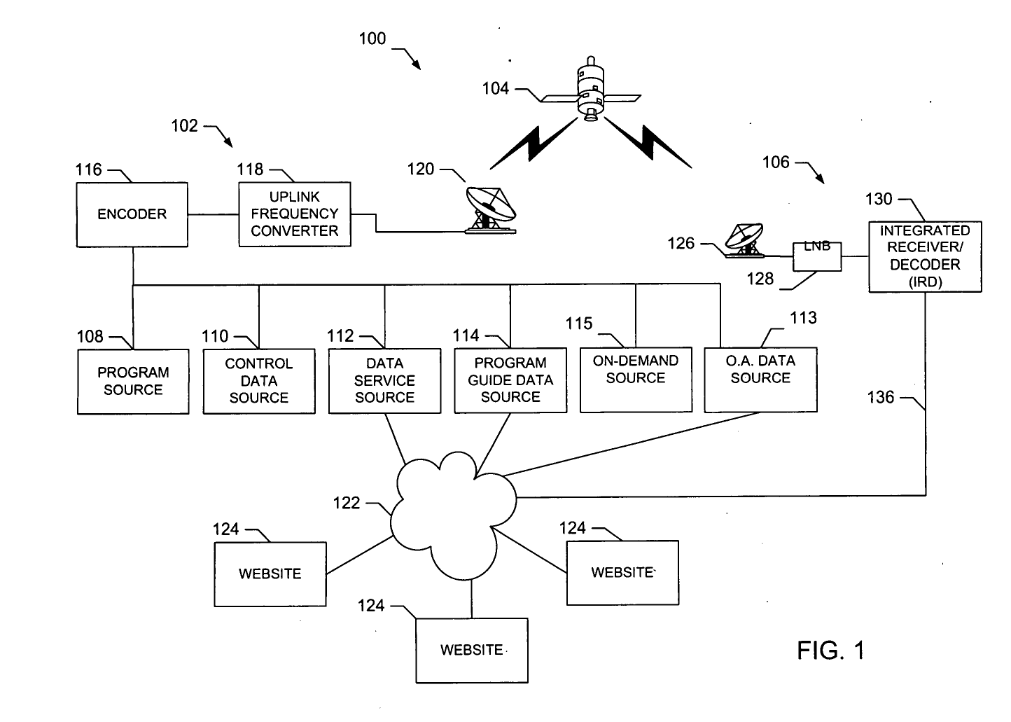

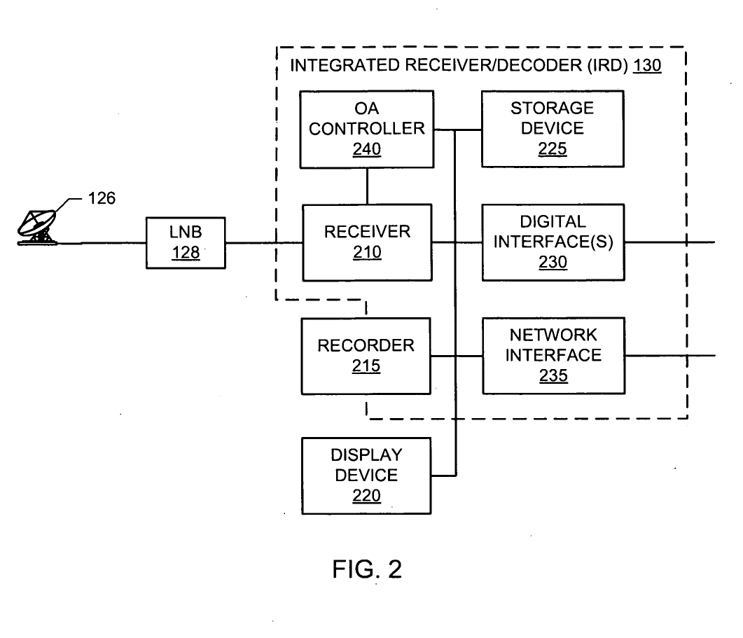

The example overlay applications and associated methods for use in a media presentation system (e.g., a home entertainment system including a media signal decoder and a television) described herein may be implemented in connection with any type of media broadcasting system including, for example, satellite broadcast systems, cable broadcast systems, radio frequency wave broadcast systems, etc. By way of illustration, an example broadcast system is described below in connection with FIG. 1 and an example receiver (e.g., set-top-boxes, broadcast signal decoders, etc.) is described in detail below in connection with FIG. 2. Further, while the following disclosure is made with respect to example DIRECTV® services and systems, it should be understood that many other delivery systems are readily applicable to the described methods and apparatus. Such systems include wired or cable distribution systems, Ultra High Frequency (UHF)/Very High Frequency (VHF) radio frequency systems or other terrestrial broadcast systems (e.g., Multi-channel Multi-point Distribution System (MMDS), Local Multi-point Distribution System (LMDS), etc.), and/or fiber optic networks.

As illustrated in FIG. 1, an example direct-to-home (DTH) system 100 generally includes a transmission station 102, a satellite/relay 104 and a plurality of receiver stations, one of which is shown at reference numeral 106, between which wireless communications are exchanged. The wireless communications may take place at any suitable frequency, such as, for example, Ku-band frequencies. As described in detail below with respect to each portion of the system 100, information from the transmission station 102 is transmitted to the satellite/relay 104, which may be at least one geosynchronous or geo-stationary satellite that, in turn, rebroadcasts the information over broad geographical areas on the earth that include receiver stations 106. To facilitate backchannel communications, the receiver stations 106 may be communicatively coupled to the transmission station 102 via a terrestrial communication link, such as a telephone line and/or an Internet connection 136. The Internet connection 136 may also facilitate other general data transfers, such as requests and responses to and from one or more servers of a network 122 and the receiver stations 106.

In further detail, the example transmission station 102 of the example system of FIG. 1 includes a plurality of sources of data and/or information (e.g., program sources 108, a control data source 110, a data service source 112, an overlay application data source 113, one or more program guide data sources 114, and an on-demand source 115). During operation, information from one or more of these sources 108, 110, 111, 112, 114, and 115 passes to an encoder 116, which encodes the information for broadcast to the satellite/relay 104. Encoding includes, for example, converting the information into data streams that are multiplexed into a packetized data stream or bitstream using any of a variety of algorithms. A header is attached to each data packet within the packetized data stream to facilitate identification of the contents of the data packet. The header also includes a service channel identifier (SCID) that identifies the data packet. This data packet is then encrypted. As will be readily appreciated by those having ordinary skill in the art, a SCID is one particular example of a program identifier (PID).

To facilitate the broadcast of information, the encoded information passes from the encoder 116 to an uplink frequency converter 118 that modulates a carrier wave with the encoded information and passes the modulated carrier wave to an uplink antenna 120, which broadcasts the information to the satellite/relay 104. Using any of a variety of techniques, the encoded bitstream is modulated and sent through the uplink frequency converter 118, which converts the modulated encoded bitstream to a frequency band suitable for reception by the satellite/relay 104. The modulated, encoded bitstream is then routed from the uplink frequency converter 118 to the uplink antenna 120 where it is broadcast toward the satellite/relay 104.

The programming sources 108 receive video and audio programming from a number of sources, including satellites, terrestrial fiber optics, cable, or tape. The video and audio programming may include, but is not limited to, television programming, movies, sporting events, news, music or any other desirable content.

Like the programming sources 108, the control data source 110 passes control data to the encoder 116. Control data may include data representative of a list of SCIDs to be used during the encoding process, or any other suitable information.

The data service source 112 receives data service information and web pages made up of text files, graphics, audio, video, software, etc. Such information may be provided via the network 122. In practice, the network 122 may be the Internet, a local area network (LAN), a wide area network (WAN) or a conventional public switched telephone network (PSTN). The information received from various sources is compiled by the data service source 112 and provided to the encoder 116. For example, the data service source 112 may request and receive information from one or more websites 124. The information from the websites 124 may be related to the program information provided to the encoder 116 by the program sources 108, thereby providing additional data related to programming content that may be displayed to a user at the receiver station 106.

The overlay application data source 113 receives and stores data to be transmitted to and used by the example overlay applications described herein, which provide a user with information (e.g., via the overlay application controller 240 of FIG. 2) information regarding, for example, a current event, a program, or a status of a device or component of a media presentation system. Further, in some examples, the overlay application data source 113 may store a collection of overlay applications to be downloaded by the user to the media presentation device (e.g., a set-top box).

Similar to the data service source 112, the overlay application data source 113 may gather data (e.g., stock prices, sports scores, news, weather reports, etc.) from a plurality of servers or other databases via the Internet or other network. Such transfers of information may be carried out using standard network protocols (e.g., HTTP, FTP, TCP/IP, etc.). In some examples, the provider of the transmission system 100 (e.g., DIRECTV®) may transmit data to the overlay application data source 113 via internal sources (e.g., a server including promotion or notification information regarding the transmission system 100). Further, where an overlay application was provided (e.g., created and made available to the user) by a third party (e.g., a television programming provider), the overlay application data source 113 may receive data directly from a server dedicated to provide information related to the third party or programming provided by the third party.

The contents of the overlay application data source 113 may be conveyed to the receiver station 106 in any of a variety of methods (e.g., similar to the transfer of data between the data source 112 and the receiver station 106). For example, the overlay application data source 113 may stream data to the receiver station 106 periodically, continuously (e.g., in a one-way push communication), or upon a request from the receiver station 106 (e.g., in a push-pull communication) via a local controller (e.g., the overlay application controller 240 described below in connection with FIG. 2). Additionally or alternatively, the overlay application data source 113 may send data to the overlay applications (e.g., which are located on the memory of a set-top box) over the network 122 (e.g., via the Internet connection 136 of FIG. 1) using standard network protocols.

The overlay application data source 113, which may be coupled to the network 122 and/or the other sources of FIG. 1, is one possible source of data for the overlay applications. Additionally or alternatively, the overlay applications may receive data directly from the network 122 (e.g., from a third party database without accessing the overlay application data source 113). In other words, the overlay applications may include the capability to retrieve or receive data from various servers over the network 122. For example, an overlay application may request data from a news agency database located on a server of the network 122, which may return data (e.g., headlines associated with a list of top news stories) related to the request. In some examples, the overlay applications may receive data from the media presentation device (e.g., the IRD 130) on which they are implemented. For example, an overlay application may request and acquire information regarding an amount of available space on a hard disk used to store on-demand programming.

The program guide data source 114 compiles information related to the SCIDs used by the encoder 116 to encode the data that is broadcast. For example, the program guide data source 114 includes information that the receiver stations 106 use to generate and display a program guide to a user, wherein the program guide may be a grid guide that informs the user of particular programs that are available on particular channels at particular times. The program guide also includes information that the receiver stations 106 use to assemble programming for display to the user. For example, if the user desires to watch a baseball game on his or her receiver station 106, the user will tune to a channel on which the game is offered. The receiver station 106 gathers the SCIDs related to the game, wherein the program guide data source 114 has previously provided to the receiver station 106 a list of SCIDs that correspond to the game. Such a program guide may be manipulated via an input device (e.g., a remote control). For example, a cursor may be moved to highlight a program description within the guide. A user may then select a highlighted program description via the input device to navigate to associated content (e.g., an information screen containing a summary of a television show episode) or active an interactive feature (e.g., a program information screen, a recording process, a future showing list, etc.) associated with an entry of the program guide.

The on-demand (OD) source 115 receives data from a plurality of sources, including, for example, television broadcasting networks, cable networks, system administrators (e.g., providers of the DTH system 100), or other content distributors. Such content may include television programs, sporting events, movies, music, and corresponding information (e.g., user interface information for OD content) for each program or event. The content may be stored (e.g., on a server) at the transmission station 102 or locally (e.g., at a receiver station 106), and may be updated to include, for example, new episodes of television programs, recently released movies, and/or current advertisements for such content. Via a user interface, which also may be updated periodically, a user (e.g., a person with a subscription to an OD service) may request (i.e., demand) programming from the OD source 115. The system 100 may then stream the requested content to the user (e.g., over the satellite/relay 104 or the network 122) or make it available for download and storage (discussed further below in connection with FIG. 2). Thus, an OD service allows a user to view, download, and/or record selected programming at any time.

The satellite/relay 104 receives the modulated, encoded Ku-band bitstream and re-broadcasts it downward toward an area on earth that includes the receiver station 106. In the illustrated example of FIG. 1, the example receiver station 106 includes a reception antenna 126 connected to a low-noise-block (LNB) 128 that is further connected to an integrated receiver/decoder (IRD) 130. The IRD 130 may be a set-top box, a personal computer (PC) having a receiver card installed therein, or any other suitable device.

The receiver station 106 may also incorporate a connection 136 (e.g., Ethernet circuit or modem for communicating over the Internet) to the network 122 for transmitting requests and other data back to the transmission station 102 (or a device managing the transmission station 102 and overall flow of data in the example system 100) and for communicating with websites 124 to obtain information therefrom.

In operation of the receiver station 106, the reception antenna 126 receives signals including a bitstream from the satellite/relay 104. The signals are coupled from the reception antenna 126 to the LNB 128, which amplifies and, optionally, downconverts the received signals. The LNB output is then provided to the IRD 130.

FIG. 2 illustrates one example manner of implementing the IRD 130 (e.g., a set-top box) of FIG. 1. The IRD 130 of FIG. 2 is merely an example and other IRD implementations are possible. The LNB output is provided to a receiver 210, which receives, demodulates, de-packetizes, de-multiplexes, decrypts and/or decodes the received signal to provide audio and video signals to a display device 220 (e.g., a television set or computer monitor) and/or a recorder 215. The receiver 210 is responsive to user inputs to, for example, tune to a particular program.

As illustrated in FIG. 2, the recorder 215 may be implemented separately from and/or within the IRD 130. The recorder 215 may be, for example, a device capable of recording information on a storage device 225, for instance, analog media such as videotape, or computer readable digital media such as a hard disk drive, a digital versatile disc (DVD), a compact disc (CD), flash memory, and/or any other suitable media. The storage device 225 is used to store the packetized assets and/or programs received via the satellite/relay 104 (e.g., a movie requested from the OD source 115). In particular, the packets stored on the storage device 225 are the same encoded and, optionally, encrypted packets created by the transmission station 102 and transmitted via the satellite/relay 104.

To communicate with any of a variety of clients, media players, etc., the example IRD 130 includes one or more digital interfaces 230 (e.g., USB, serial port, Firewire, etc.). To communicatively couple the example IRD 130 to, for instance, the Internet and/or a home network, the example IRD 130 includes a network interface 235 that implements, for example, an Ethernet interface.

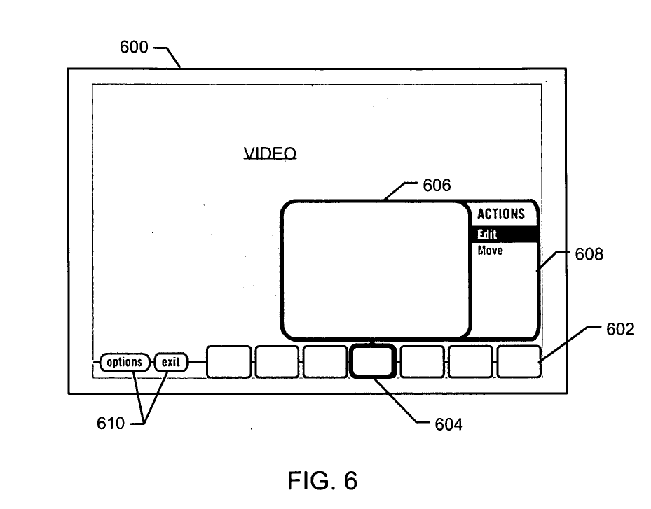

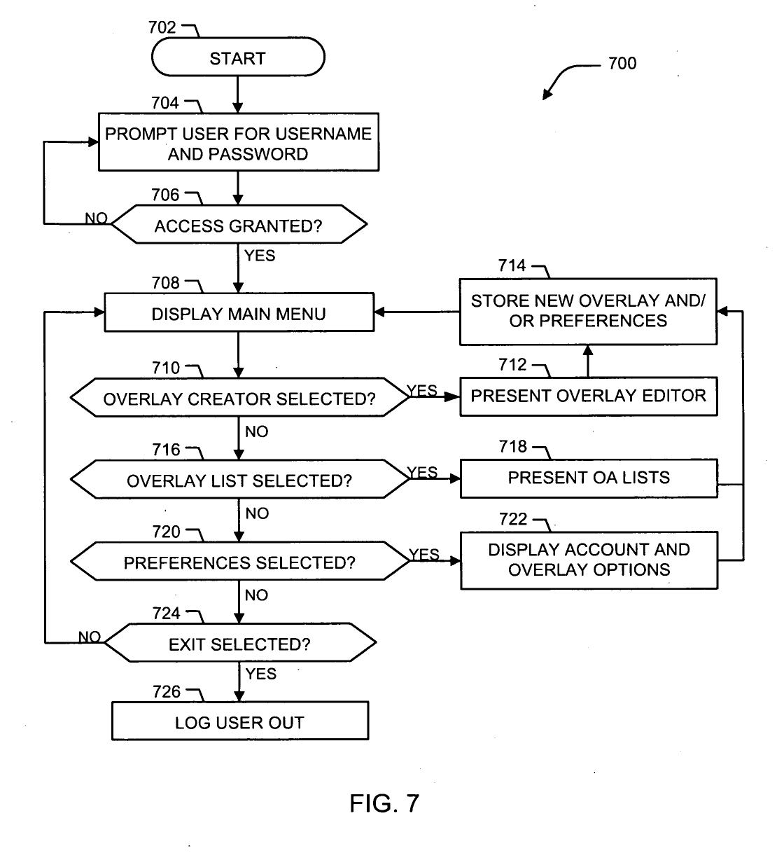

Further, the example IRD 130 includes an example overlay application controller 240 to manage and/or operate a collection of overlay applications that may be executed to display information (e.g., a graphical representation of data related to current events or devices related to the corresponding overlay application) on or in connection with, for example, an element of a user interface (e.g., a program guide) or over broadcast media (e.g., in expandable sections of a list as described in connection with FIG. 6). Additionally, the overlay application controller 240 may enable the user to select, configure, and/or customize one or more overlay applications and a presentation thereof In some examples, the overlay application controller 240 stores the user-defined collection of overlay applications (e.g., in local memory of the IRD 130). In some examples, the overlay application controller 240 may manage a default set of overlay applications created and/or stored (e.g., on the local memory of the IRD 130) by a content delivery system provider (e.g., DIRECTV®). In some examples, a broader collection of available overlay applications may be stored on an external source (e.g., the overlay application data source 113 or a third party server coupled to the network 122) in communication with the overlay application controller 240. As described below in connection with FIG. 7, the broader collection may be accessed via a website associated with a user account to enable the user to select additional overlay applications for a collection. Generally, the user may login (e.g., by entering a username and password into input fields of the website) to the account and manage (e.g., modify which overlay applications to include in the collection presented to the user for a selection of which overlay applications to execute) the settings, contents, and/or configurations of the overlay applications.

As described above, the example overlay application controller 240 may send and/or receive data to and/or from various sources (e.g., the overlay application data source 113) via various components (e.g., the network interface 235, the display device 220, the LNB 128) of the transmission system 100 to implement the presentation and/or operation of the overlay applications and information associated therewith. The overlay applications may receive streaming information in a push communication scheme or periodically in a push-pull communication scheme. In some examples, only a select number of overlay applications may be active at a given time. In other words, the user may define a subset of the collection of overlay applications as active or executing. Accordingly, the overlay application controller 240 may refuse (e.g., block) to accept any data related to inactive overlay applications, thereby increasing efficiency, available bandwidth, and memory space. Such an operation may be facilitated by, for example, setting a designated bit as high for active overlay applications to indicate that data may be received.

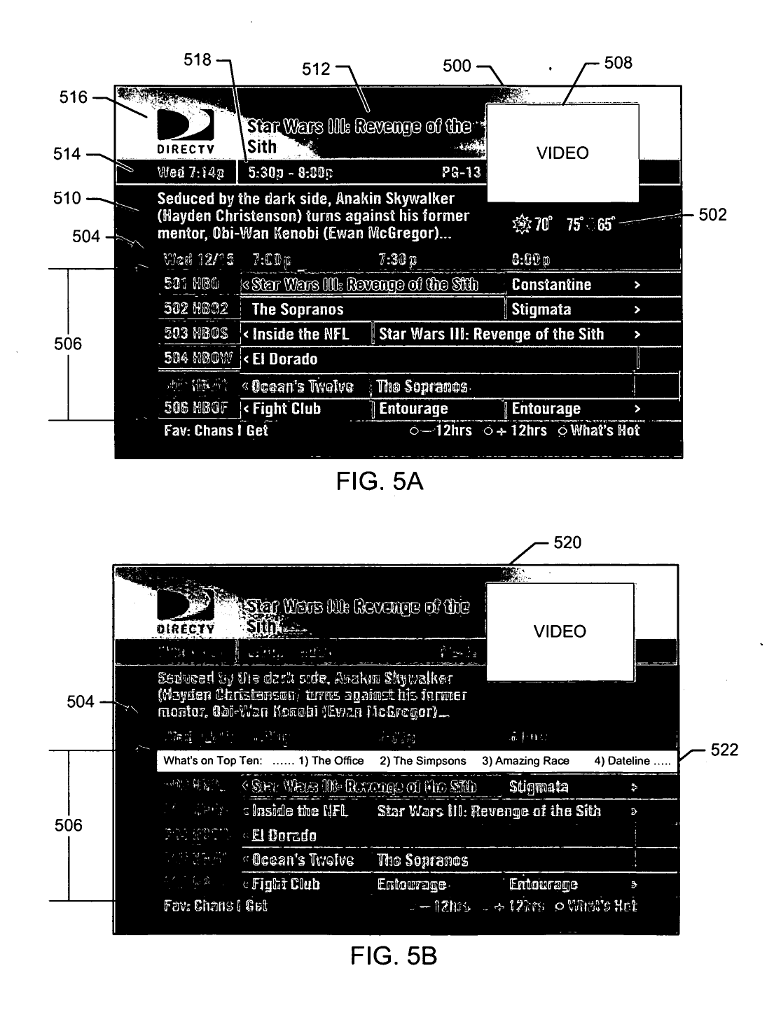

The example overlay applications described herein are applications (e.g., applets or widgets) that present a user (e.g., via an overlay) with dynamic and/or substantially live information associated with, for example, a current event, a program, or a status of an element of the media presentation system on which the overlay applications are implemented. An example overlay application may convey information associated with local weather, sports scores, stock market data, ski reports, airline flight information, currently popular television shows or movies, a time until the start of a certain program, a list of programs currently being watched by other users, etc. Additionally or alternatively, the overlay applications may present the user with information associated with the media presentation system, such as an amount of available hard disk space, the amount of recorded programs in a playlist, the next program scheduled for recording or downloading, etc. Further, overlay applications may be displayed individually (e.g., as the overlays 502 and 522 shown in the screenshots 500 and 550 of FIGS. 5A and 5B), in a list format (e.g., as the overlay list 602 shown in the screenshot 600 of FIG. 6), on an overlay application homepage or menu dedicated to the overlay application feature, or in any other configuration as determined by a user, a provider of the overlay applications (e.g., a content provider), or a content delivery system provider (e.g., DIRECTV®).

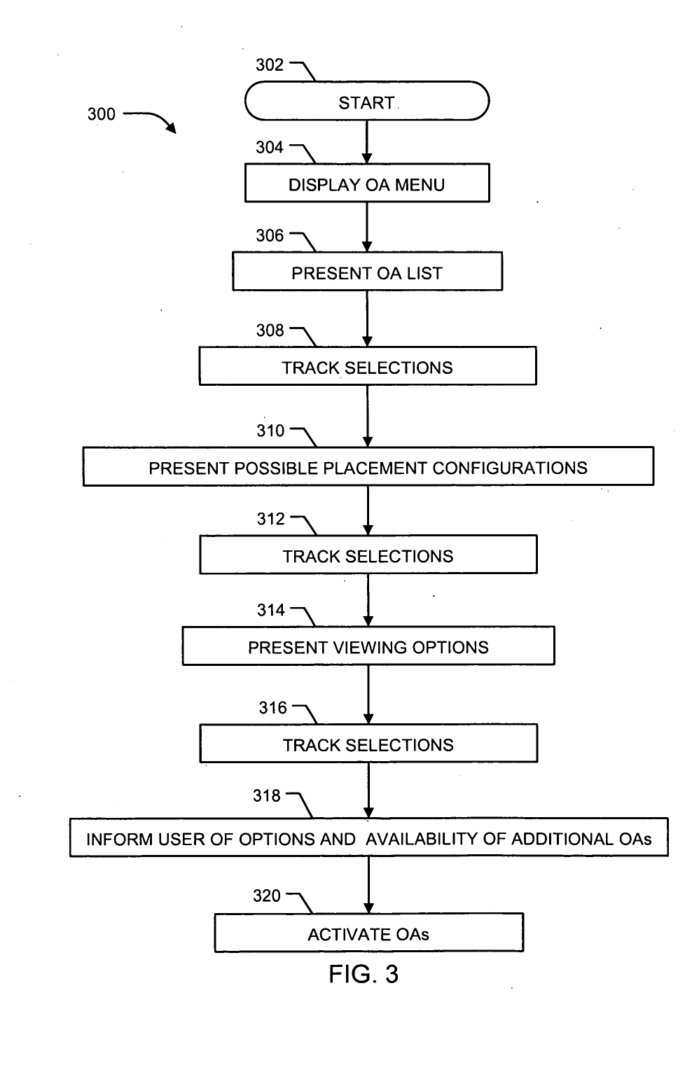

As described below in connection with FIG. 3, one or more aspects and/or characteristics (e.g., a position on a display screen, a font, a color, a duration of display) of the example overlay applications may be customizable by the user, while other characteristics may be fixed to a default setting. A customization and/or creation of an overlay application may be facilitated by a user interface implemented on the IRD 130 (e.g., via the process 300 described in connection with FIG. 3) and/or a web interface (e.g., via the process 700 of FIG. 7) providing a user access to an account including, for example, customized overlay applications and any associated settings. Available overlay applications may include those created by the user or those designed by a content provider, the content delivery system provider, manufacturers, or any other third party (e.g., other users of similar overlay application features).

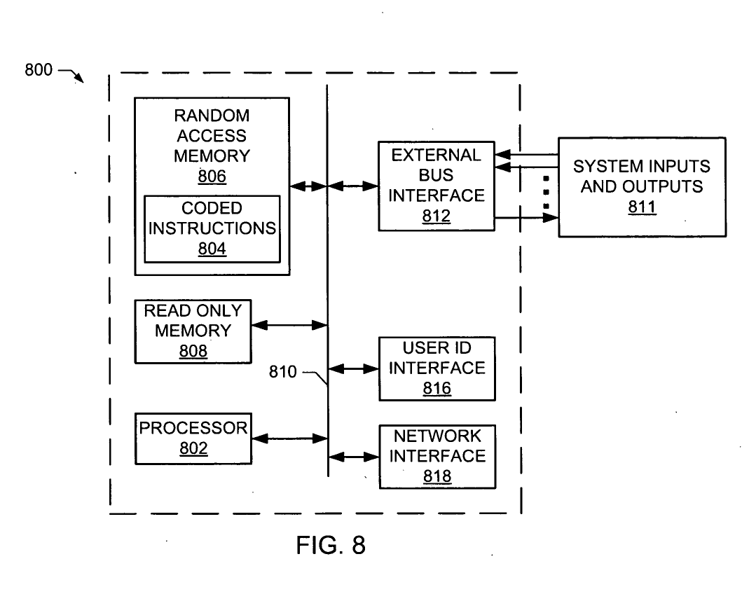

Although the following discloses example processes through the use of flow diagrams having blocks, it should be noted that these processes may be implemented in any suitable manner. For example, the processes may be implemented using, among other components, software, or firmware executed on hardware. However, this is merely one example and it is contemplated that any form of logic may be used to implement the systems or subsystems disclosed herein. Logic may include, for example, implementations that are made exclusively in dedicated hardware (e.g., circuits, transistors, logic gates, hard-coded processors, programmable array logic (PAL), application-specific integrated circuits (ASICs), etc.), exclusively in software, exclusively in firmware, or some combination of hardware, firmware, and/or software. For example, instructions representing some or all of the blocks shown in the flow diagrams may be stored in one or more memories or other machine readable media, such as hard drives or the like (e.g., the memories 806 and/or 808 of FIG. 8). Such instructions, which may be executed by one or more processors (e.g., the processor 802 of FIG. 8), may be hard coded or may be alterable. Additionally, some portions of the processes may be carried out manually. Furthermore, while each of the processes described herein is shown in a particular order, those having ordinary skill in the art will readily recognize that such an ordering is merely one example and numerous other orders exist. Accordingly, while the following describes example processes, persons of ordinary skill in the art will readily appreciate that the examples are not the only way to implement such processes. Further, while certain buttons (e.g., ‘Select’) are described below, it will be appreciated that the titles or names of such buttons are meant for illustrative purposes and that other suitable names, symbols, or numbers may be assigned to similar buttons to represent the following instructions, features, options, and/or instructions similar thereto.

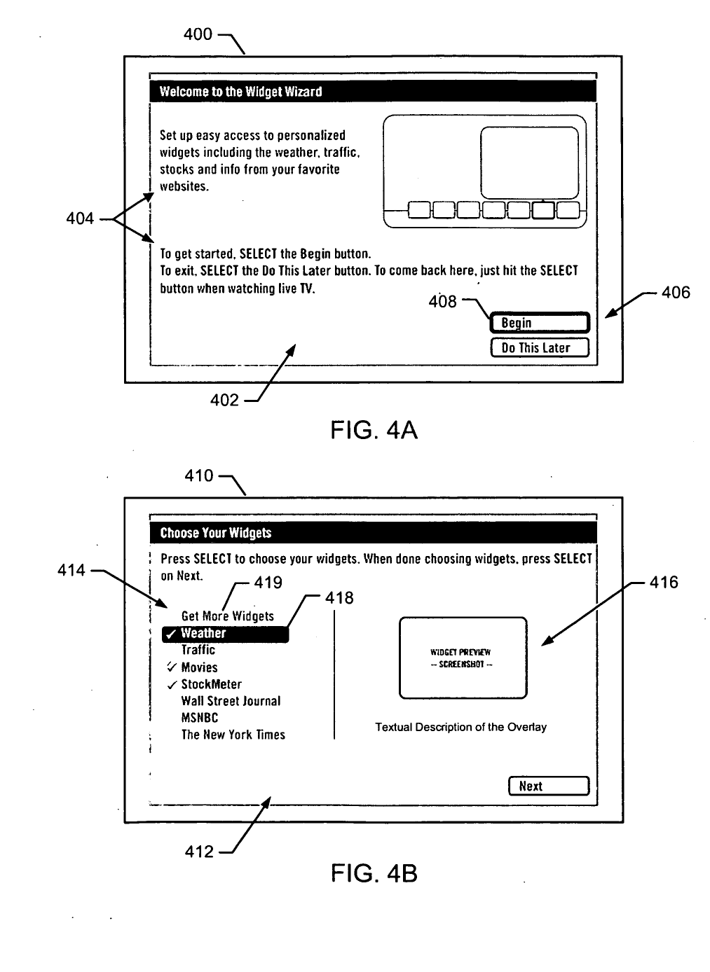

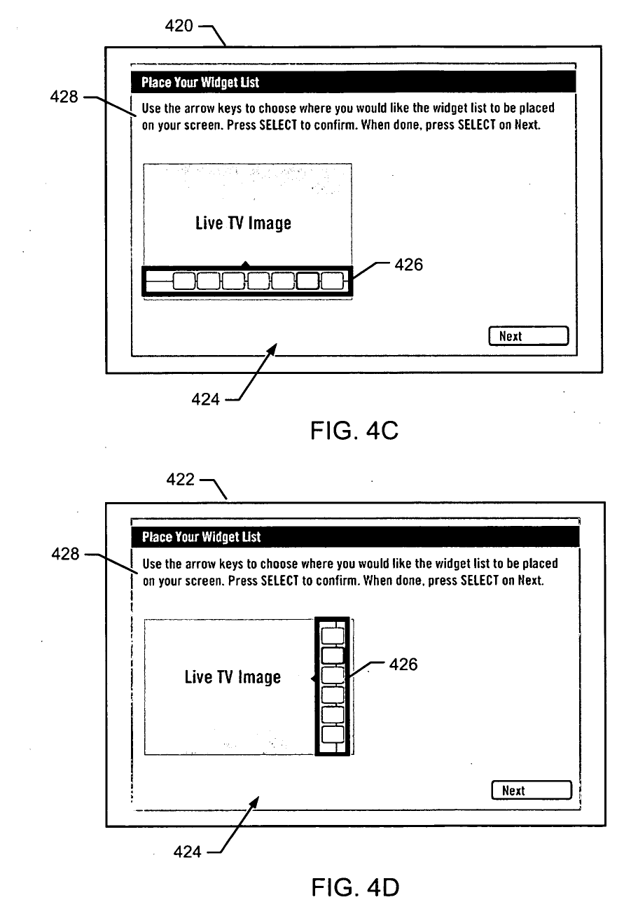

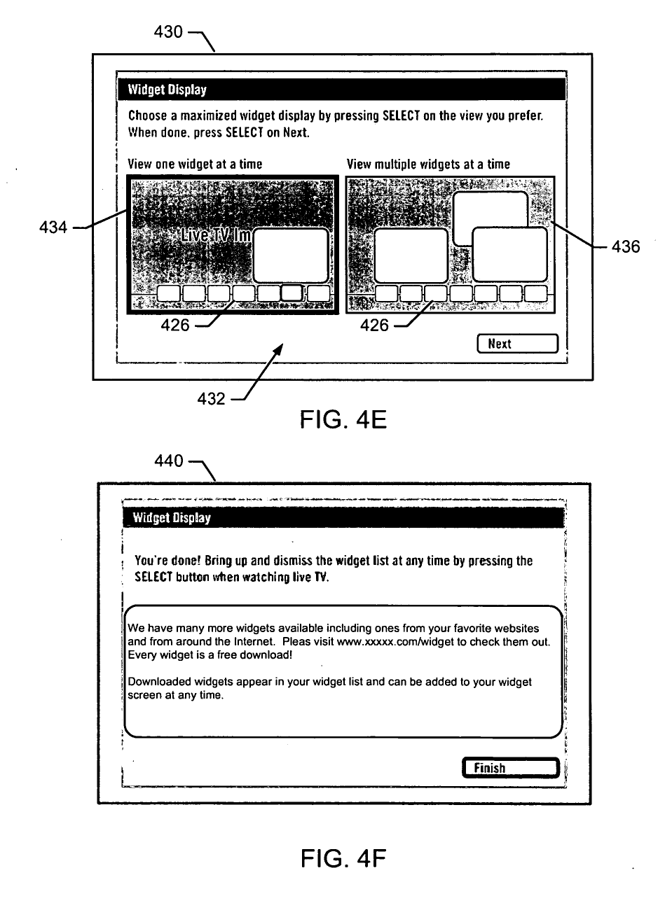

FIG. 3 is a flowchart representing an example process 300 that may be implemented via, for example, the IRD 130 and/or the overlay application controller 240 of FIGS. 1 and 2. Specifically, the example process 300 enables a user to select, configure, and/or interact with one or more overlay applications from one or more sources (e.g., a collection of overlay applications stored on the IRD 130 or the overlay application data source 113 of FIG. 1). For illustrative purposes, the process 300 is described with example screenshots 400, 410, 420, 422, 430, and 440 of FIGS. 4A-F. However, the example process 300 and the example screenshots 400, 410, 420, 422, 430, and 440, and the associated features and methods described herein, are non-limiting examples meant for illustrative purposes. Further, the overlay applications or the overlays produced by the overlay applications may be described as ‘widgets’ when presenting information or options regarding the overlay applications. However, the term ‘widgets’ is meant as an illustrative example of a term that may be assigned to the overlay applications or the overlays produced by the overlay applications for aesthetic purposes (e.g., as a user-friendly title).

The process 300 starts with an activation of an overlay application feature or an option thereof (block 302). The activation may occur upon, for example, a selection of the overlay application feature from a menu or remote control. For example, a remote control may include a button dedicated to the overlay application feature or a multi-function button that may be assigned the function of activating the overlay application feature in a certain state of the user interface. Further, where one or more overlay applications have been previously set up (e.g., selected and configured), the engagement of an ‘Overlay-Edit’ option or on-screen button may activate the overlay application feature. Upon activation, an overlay application menu may be presented to the user (block 304). For example, the screenshot 400 of FIG. 4A shows an example overlay application main menu 402 including general instructions 404 and options 406 (e.g., buttons that may be highlighted and selected via a remote control) regarding the overlay applications.

If the user chooses to proceed with the selection and/or configuration of the overlay applications and presentation thereof (e.g., by selecting ‘Begin’ from the options 406), a list of available overlay applications (e.g., the user-defined collection of overlay applications stored on the IRD 130) may be presented to the user (block 306). For example, the screenshot 410 of FIG. 4B shows a selection screen 412 including a list 414 of overlay applications from which the user may select one or more overlay applications for execution. The list 414 may be organized in categories and/or subcategories. For example, the user may select a sports category (e.g., professional football), which may cause a subcategory of teams to be displayed, from which the user may select an overlay application associated with a favorite team. As the user scrolls down the list 414 (e.g., via a highlight cursor 418) and determines which overlay applications to activate, an indication (e.g., a check mark as illustrated in FIG. 4B) may be placed next to the selected overlay application. Selections from the list 414 may be tracked and stored (e.g., in the random access memory 806 or read-only memory 808 of FIG. 8) as personal preferences (e.g., for a current user in a multi-user system) or general system settings (block 308).

The example selection screen 412 also includes a preview section 416 having a graphical preview and/or textual description of a highlighted element of the list 414. Further, the selection screen 412 may include an option 419 to obtain or review additional more overlay applications (e.g., from a broader collection stored on the overlay application data source 113). As described below in connection with FIG. 7, the user may access one or more sources (e.g., a third-party server via the network 122, the overlay application data source 113, etc.) to acquire such additional overlay applications (e.g., via a download from the Internet). Further, where the overlay application feature is accessed after an initial set up, the selection screen 412 may be presented (e.g., without the display of the main menu 402) to provide quicker access to the selection process.

When one or more overlay applications have been selected, the user may also define a display position for one or more overlays produced by the overlay applications via a placement screen (block 310), and the process 300 may track any positioning selections (block 312). The screenshots 420 and 422 of FIGS. 4C and 4D show an example placement screen 424 including a list 426 having a plurality of sections to contain one or more overlays. As shown by the example alternate positions of the list 426 and the associated instructions 428 in FIGS. 4C and 4D, the user may define the position, configuration, and/or arrangement of the list 426 and the contents thereof. While the example placement screen 424 of FIGS. 4C and 4D enable a placement of a group of overlays (e.g., the list 426) overlays may also be individually displayed, for example, over a full-screen presentation of media (e.g., a live television program) or in connection with an element of the user interface (e.g., in a margin of a program guide). In such examples, the process 300 may include additional or alternative placement screens to enable a user to individually position one or more overlays. For example, an overlay related to a sporting event (e.g., a football game) may be positioned in a bottom corner of a screen presenting a broadcast of another sporting event (e.g., a basketball game). In another example, an overlay related to local weather may be positioned in a corner of a program guide and displayed in that positioned whenever the user accesses the program guide. In some examples, an overlay may be displayed proximate to a navigation bar (e.g., an indicator of whether a program is being rewound, fast forwarded, or paused) whenever the navigation bar is displayed (e.g., as triggered by an engagement of a button on a remote control). Further, one or more overlays be displayed on an overlay application home page that can be accessed in a similar manner as a program guide. In other words, the user interface of the media presentation system may include a screen dedicated to the overlay applications, which may display, for example, all of the active overlay applications. For example, the overlays produced by the active overlay applications may arranged in a grid format and may be selected via a cursor to perform any of the interactions described herein.

Further, additional option screens may be provided to enable one or more additional preference settings. In the example process 300 of FIG. 3, the user is presented with viewing options associated with the display of the overlays in connection with the list 426 (block 314). The screenshot 430 of FIG. 4E shows an example viewing options screen 432 having a plurality of viewing options to choose from. Specifically, the viewing options screen 432 includes an option 434 to view information associated with one overlay application at a time (e.g., as expanded from the list 426 as described below in connection with FIG. 6) and another option 436 to view information associated with multiple overlay applications at a time. The example viewing options screen 432 is meant for is meant for illustrative purposes as additional or alternative option screens may be utilized in a similar process. For example, another options screen may enable the user to select a duration of display for one or more overlays. Where multiple overlay applications are active, the display of one overlay may be replaced by the display of another overlay after a set period of time, which may be defined by the user. In other words, the overlays many automatically cycle or toggle. In some examples, the user may also manually toggle or cycle between active overlays via, for example, a dedicated button on a remote control. Other buttons may enable a one-touch activate/deactivate feature that displays or removes the overlays from the display screen (e.g., temporarily or permanently).

Any user selections may be tracked (block 316) and the process 300 may proceed to present a screen informing the user that the set-up process is complete and that additional overlay applications may be acquired at a website (as described in more detail below in connection with FIG. 7) (block 318). Then, the example process 300 activates the selected overlay applications (block 320) and enables an execution of the overlay applications to display updated information as described herein.

FIG. 5A shows an example screenshot 500 including an example overlay 502 as displayed by a weather-related overlay application. As described above, the example screenshot 500 and the overlay 502 are non-limiting examples and are meant for illustrative purposes. Further, the data used by the overlay application to display the example overlay 502 may be received in any of the variety of manners described above. The example screenshot 500 shows an example portion 504 of an example user interface over which the overlay 502 is displayed. Specifically, the example portion 504 includes a list 506 of available content or programs. For example, the list 506 may include programs being broadcast or scheduled for broadcast over the DTH transmission system 100. The example portion 504 of the user interface may also include a video section 508 to display a currently tuned channel or recorded content being played back, an information section 510, a title section 512, a current date and time 514, a source indicator 516 (e.g., a logo), a duration section 518, and/or additional or alternative features to assist the user utilize the media presentation system. As described above, the position of the overlay 502 may be defined by the user (e.g., via a process similar to that of the process 300 of FIG. 3) or a system administrator (e.g., a programmer or system designer). In this example, the overlay 502 is positioned below the video section 508.

The example overlay 502 shows a status of the weather in, for example, the area in which the user resides (e.g., where the receiving station 106 is geographically located). Such a weather-related overlay application may use zip code information gathered by a user entry or from information associated with an account (e.g., a billing address). The example overlay 502 includes a graphic (e.g., a sun) to indicate a general condition, a current temperature, a high temperature, and a low temperature, as expected for the current day. In some examples, the overlay 502 may additionally or alternatively include forecast information. The graphics of the overlay 502 may be animated and may shift or jump locations to, for example, catch the attention of the user (e.g., where a weather-related warning has been issued). Further, the overlay 502 may appear or disappear based on various criteria. For example, the overlay 502 may be displayed to the user at a certain time of day (e.g., during morning hours at which time the user may be preparing for work), or on certain days of the week (e.g., on Sundays or Saturdays to inform the user of sporting events that occur on those days).

As described above, the contents of the overlay 502 may be updated periodically, continuously, or only at times when changes in the information related to the overlay 502 are occurring. As the example overlay 502 is related to weather, which is constantly changing, the overlay 502 may be updated every five to ten minutes, as an example. In some examples, the information related to an overlay may not change for a significant period of time and, in such a case, the overlay application may not execute for that dormant time period. For example, because trading markets are open during a portion of the day, an overlay application that displays a stock ticker may only update its information during a portion of the day. Specifically, a stock ticker overlay application may include one mode of operation that enables a receipt of data and another dormant mode of operation (i.e., where data cannot be received). This may free up processing capabilities and bandwidth that would otherwise be wasted.

FIG. 5B shows an example screenshot 520 including another example overlay 522 as displayed by a dynamic ticker overlay application. The example overlay 522 is shown with the example portion 504 of the user interface as illustrated in FIG. 5A. The example overlay 522 is positioned within the list 506 and may be animated to enable the contents of the overlay 522 to scroll. The speed of the scrolling, as well as the content (e.g., which type of information) of the dynamic ticker, may be modified by the user. Further, some examples may provide alternative mechanisms of display and/or animation (e.g., swapping, sliding, dissolving, etc.) based on the size of the ticker and/or user preferences or default system settings. The example overlay 522 shows a list (e.g., a top ten list) of the programs (e.g., television shows) that users are or currently have been watching. The list may be derived from tuning information stored at the overlay application data source, ratings information gathering from the Internet via the network 122, or from any other suitable source 113. Further, as described below in connection with FIG. 7, the overlay 522 may be configured or designed by a third party (e.g., a content provider, system administrator, etc.) or the user (e.g., via an editing tool of a website associated with a user account).

In some examples, one or more overlays (e.g., the overlays 502 and 522 of FIGS. 5A and 5B) may be displayed over a full-screen display of media (e.g., over a currently tuned television program or music stream). Such overlays may be individually positioned in, for example, a corner of the screen or set in a list including a plurality of overlays (as described in connection with FIGS. 4A and 4B). FIG. 6 shows an example screenshot 600 including an example overlay list 602 having a plurality of cells to include a plurality of overlays. The cells of the example list 602 are expandable to enlarge the display of one or more of the overlays. For example, a highlighted cell 604 (e.g., via a cursor that may be moved from one element of the list 602 to another using the buttons on a remote control) may be selected (e.g., by engaging a ‘Select’ button on a remote control), causing an enlarged cell 606 to expand from the list 602. The engagement of another option (e.g., an ‘Edit’ or ‘Options’ button on a remote control) may cause a list 608 of options to be presented in connection with the enlarged cell 606. For example, the user may edit the overlay contained within the enlarged cell 606 or may choose to modify the position (e.g., by engaging the ‘Move’ option) of the list 604, the enlarged cell 606, or a combination thereof The list 604 may also include general options 610 to enable the user to access different options of the overlay feature (e.g., via the selection screen 412 of FIG. 4B) or to exit the overlay feature (e.g., to remove the display of the active overlays). In some examples, more than one overlay may be enlarged at any one time with or without the list 604 being concurrently displayed. Further, the configuration of the example list 604 is meant for illustrative purposes, as some examples may include other arrangements, shapes, sizes, number of cells, etc. For example, overlays may be displayed in a disconnected grouping in the four corners of the display.

As described above, the overlay applications and the associated features or characteristics thereof may be linked to and/or tracked by a user account. Such an account may be accessed and/or modified via, for example, a website linked to the overlay application data source 113 of FIG. 1. FIG. 7 is a flowchart representing an example process 700 to enable a user to access and/or modify the settings and contents of a user account that manages an example overlay application feature. Specifically, the example process 700 enables the user to review, create, and/or modify the overlay applications of a user collection via a website. The process 700 begins when a user requests information from a website (e.g., www.directv.com/widgets) by, for example, entering an address into a web browser (block 702). The user may be required to enter a user name and password to direct the website to a specific user account and to verify the identity of the user (block 704). Once access is granted (block 706), a main menu may be displayed, including general account details and a plurality of options (e.g., hyperlinks) associated with the user account and the overlay feature (block 708).

For example, the user may choose to create an overlay application on the website (block 710), thereby triggering a presentation of a editing tool (e.g., a JAVA® script or Flash® editor or builder) (block 712). The editing tool may enable a selection of different components (e.g., graphics or dynamic objects designed by a system administrator) to build an overlay by dragging the components together in a user-defined configuration. In other words, the user may customize or define different elements to be displayed by the associated overlay application. For example, the user may select a graphic representative of a city (e.g., an arch to represent the city of St. Louis, Mo.) along with a weather related overlay application (e.g., the overlay application associated with the overlay 502 of FIG. 5A). Further, the user may position the representative graphic over the weather-related overlay, thus creating an overlay application that displays weather information and an indication of what geographic location to which the information pertains.

Additionally or alternatively, user created code templates (e.g., files created using HTML, XML, or other scripting or programming languages) defining an overlay may be created using an external source (e.g., a personal computer) and uploaded to the website. Such templates may then be converted (e.g., by a server administered by the content delivery system provider) to a compatible overlay application that may be downloaded onto, for example, a set-top box or component thereof (e.g., the overlay application controller 240 of FIG. 2). When an overlay application is created by any of the above methods, the process 700 proceeds to store the user-created overlay applications and the information associated therewith (block 714). Such data may be stored locally (e.g., on the overlay application controller 240 of the IRD 130) or remotely (e.g., on the overlay application data source 113).

Another example option is the addition or removal of overlay applications from the collection of the user (e.g., as tracked by the user account and/or the overlay application controller 240). A selection of such an option (block 716) triggers a presentation of a list of available overlay applications, including those designed by, for example, the user, other users, third parties (e.g., content providers or other website hosts, such as Google® or Yahoo®), or system administrators (block 718). Some overlay applications may requires a subscription (e.g., to a premium channel) or may be purchased (e.g., in a manner similar to a purchase of pay-per-view movies). Some overlay applications may be supported by a sponsor or advertiser.

In some examples, different users may share any overlay applications they have created by uploading them to a database (e.g., at the overlay application data source 113) for other users of a similar system to download. The list of available overlay applications may also include those created by a third party (e.g., a content provider). For example, the entity responsible for providing a certain game show may create an overlay application that presents a program-related trivia game, a countdown to a next episode, a news ticker regarding the program (e.g., the winner or prize won of the last episode), or an overlay application that is synced with a broadcast of the program to correspond with events of each episode. In some examples, a manufacturer of a component of the media presentation system (e.g., the IRD 130) may design and/or create a troubleshooting overlay application or a overlay application to notify users of available upgrades or other products (e.g., advertisements). Additionally or alternatively, the overlay applications may incorporate advertisements. For example, where a user has set multiple overlays to toggle or cycle, an advertisement may be interjected into the cycle or progression of overlays. Some example overlay applications may be solely dedicated to advertisements, which may cycle and update according to newly available products or sales thereof.

Such overlay applications may be made available in categorized lists that may be navigated via typical website functions. The user may select one or more of the available overlay applications for addition to the collection of overlay applications that may be activated on the media presentation system of the user. Further, the current collection of overlay applications may be presented to the user on the website for a removal of one or more overlay applications from the collection (e.g., by dragging an icon representing an overlay application out of a window including the collection). After the user has made such additions and/or removals from the collection, the process 700 may store the modified data (block 714) and return to the main menu (block 708).

Another example option is a general preferences menu associated with the options and/or settings of the overlay application feature. Where such an option is selected (block 720), the process 700 may display a menu including the current settings of the user account (e.g., subscriptions, billing address, sharing capabilities, affiliations, etc.) and/or the overlay feature (e.g., positioning, time of display, configuration, transparency, etc.) (block 722). The settings and/or options may be altered using any common website mechanism and the results may be stored (block 714). Further, the process 700 may be exited via a selection of an exit button or on-screen option (block 724), causing the user to be logged off the account (block 726).

The overlay applications described herein may also be interactive (e.g., responsive to the selection or engagement of an ‘Enter or ‘Record’ button during the selection or highlighting of the overlay) or passive (e.g., unable to be selected in a certain display mode). Further, interactive overlay applications may be switched (e.g., manually by the user) to passive where no interaction is desired. In some examples, an interactive overlay application may be highlighted and acted upon by, for example, engaging a ‘Record’ button, causing a scheduling of a recording of a program related to the content of the overlay. For example, where an overlay indicates a time and date of a new episode of a television series, the user may select a ‘Record’ button to record the episode or an ‘Info’ button to present an information screen related to the episode. Another example interactive overlay application may enable the user to tune to a channel broadcasting a program related to the overlay, such as a sporting event broadcast corresponding to a score displayed in the overlay. Thus, the example overlays (e.g., those implemented by the overlay controller 240) and the associated methods described herein provide readily viewable (i.e., immediately available) applications that convey updated information to the user in an efficient, convenient, and customizable manner.

FIG. 8 is a schematic diagram of an example manner of implementing an example processor unit 800 to execute the example methods and apparatus described herein. The example processor unit 800 of FIG. 8 includes a general purpose programmable processor 802. The example processor 802 may execute, among other things, machine accessible instructions 804 (e.g., instructions present within a random access memory (RAM) 806 as illustrated and/or within a read only memory (ROM) 808) to perform the example processes described herein. The example processor 802 may be any type of processing unit, such as a microprocessor.

The processor 802 may be coupled to an interface, such as a bus 810 to which other components may be interfaced. The example RAM 806 may be implemented by dynamic random access memory (DRAM), Synchronous DRAM (SDRAM), and/or any other type of RAM device, and the example ROM 808 may be implemented by flash memory and/or any other desired type of memory device. Access to the example memories 808 and 806 may be controlled by a memory controller (not shown) in a conventional manner.

To send and/or receive system inputs and/or outputs 811, the example processor unit 800 includes any variety of conventional interface circuitry such as, for example, an external bus interface 812. For example, the external bus interface 812 may provide one input signal path (e.g., a semiconductor package pin) for each system input. Additionally or alternatively, the external bus interface 812 may implement any variety of time multiplexed interface to receive output signals via fewer input signals.

To allow the example processor unit 800 to interact with a remote server, the example processor unit 800 may include any variety of network interfaces 818 such as, for example, an Ethernet card, a wireless network card, a modem, or any other network interface suitable to connect the processor unit 800 to a network. The network to which the processor unit 800 is connected may be, for example, a local area network (LAN), a wide area network (WAN), the Internet, or any other network. For example, the network could be a home network, an intranet located in a place of business, a closed network linking various locations of a business, or the internet.

Although an example processor unit 800 has been illustrated in FIG. 8, processor units may be implemented using any of a variety of other and/or additional devices, components, circuits, modules, etc. Further, the devices, components, circuits, modules, elements, etc. illustrated in FIG. 8 may be combined, re-arranged, eliminated and/or implemented in any of a variety of ways.

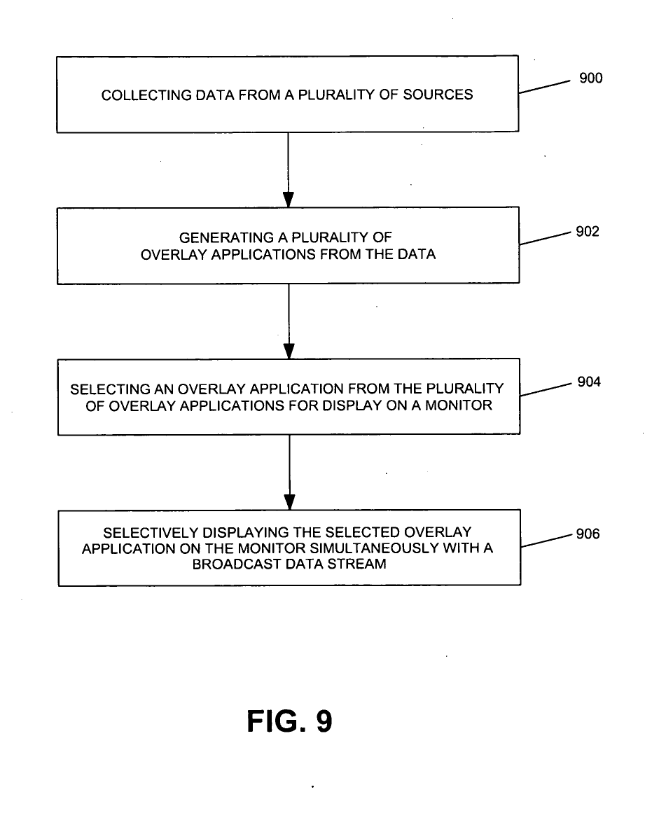

FIG. 9 is a process chart illustrating an embodiment of the present invention.

Box 900 illustrates collecting data from a plurality of sources.

Box 902 illustrates generating a plurality of overlay applications from the data.

Box 904 illustrates selecting an overlay application from the plurality of overlay applications for display on a monitor.

Box 906 illustrates selectively displaying the selected overlay application on the monitor simultaneously with a broadcast data stream.

### Conclusion

The systems, apparatuses, and methods described above are non-limiting examples. Although the example apparatus and methods described herein include, among other components, software executed on hardware, such apparatus and methods are merely illustrative and should not be considered as limiting. For example, it is contemplated that any or all of the disclosed hardware and software components could be embodied exclusively in dedicated hardware, exclusively in software, exclusively in firmware or in some combination of hardware, firmware, and/or software.

A method of using overlay applications within a broadcast communications system in accordance with one or more embodiments of the present invention comprises collecting data from a plurality of sources, generating a plurality of overlay applications from the data, selecting an overlay application from the plurality of overlay applications for display on a monitor, and selectively displaying the selected overlay application on the monitor simultaneously with a broadcast data stream.

Such a method further optionally comprises updating the selected overlay application prior to selectively displaying the selected overlay application, updating the selected overlay application comprises streaming data to the selected overlay application, determining a location on the monitor for display of the selected overlay application, storing at least a subset of the plurality of overlay applications at a set-top box, and creating a custom overlay application, and including the custom overlay application in the plurality of overlay applications.

An apparatus for displaying a broadcast data stream and a user-selected overlay application on a monitor in a broadcast communications system, in accordance with one or more embodiments of the present invention comprises a receiver, an overlay application controller, coupled to the receiver, a storage device, coupled to the overlay application controller and the receiver, a network interface, coupled to the controller and the receiver, and a user interface, coupled to the controller, wherein at least one overlay application is selected via the user interface, received at the receiver, stored in the storage device, and selectively displayed simultaneously with the broadcast data stream on the monitor.

Such an apparatus further optionally comprises the at least one overlay application being received at the receiver via the network interface, the at least one overlay application being received at the receiver via the broadcast communications system, the broadcast communications system being a satellite broadcast system, updating the overlay application when the overlay application is selectively displayed on the monitor, updating the overlay application comprising streaming data to the overlay application, determining a location on the monitor for display of the overlay application via the user interface, and creating a custom overlay application via the user interface.

A system for displaying a broadcast data stream and a user-selected overlay application on a monitor in a broadcast communications system in accordance with one or more embodiments of the present invention comprises a transmission system for transmitting a plurality of broadcast data streams and for transmitting and generating a plurality of overlay applications, a receiver for receiving the plurality of broadcast data streams and the plurality of overlay applications, an overlay application controller, coupled to the receiver, for executing the plurality of overlay applications, and a user interface, coupled to the receiver, for selecting the user-selected overlay application from the plurality of overlay applications, wherein the user-selected overlay application is displayed on the monitor simultaneously with the broadcast data stream.

Such a system further optionally comprises a network interface, coupled to the receiver, wherein the network interface further receives the plurality of overlay applications from the transmission system, a memory, coupled to the receiver and the network interface, wherein the user-selected overlay application is stored in the memory, the transmission system being a satellite broadcast system, the user-selected overlay application being customized via the user interface, and the user-selected overlay application being created via the user interface.

The foregoing description of the preferred embodiment of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but by the claims appended hereto and the full range of equivalents to the claims appended hereto.

What is claimed is:

1. A method of using overlay applications within a broadcast communications system, comprising:
collecting data from a plurality of sources;
generating a plurality of overlay applications from the data;
selecting an overlay application from the plurality of overlay applications for display on a monitor; and
selectively displaying the selected overlay application on the monitor simultaneously with a broadcast data stream.

2. The method of claim 1, further comprising updating the selected overlay application prior to selectively displaying the selected overlay application.

3. The method of claim 2, wherein updating the selected overlay application comprises streaming data to the selected overlay application.

4. The method of claim 1, further comprising determining a location on the monitor for display of the selected overlay application.

5. The method of claim 1, further comprising storing at least a subset of the plurality of overlay applications at a set-top box.

6. The method of claim 1, further comprising creating a custom overlay application, and including the custom overlay application in the plurality of overlay applications.

7. An apparatus for displaying a broadcast data stream and a user-selected overlay application on a monitor in a broadcast communications system, comprising:
a receiver;
an overlay application controller, coupled to the receiver;
a storage device, coupled to the overlay application controller and the receiver;
a network interface, coupled to the controller and the receiver; and
a user interface, coupled to the controller, wherein at least one overlay application is selected via the user interface, received at the receiver, stored in the storage device, and selectively displayed simultaneously with the broadcast data stream on the monitor.

8. The apparatus of claim 7, wherein the at least one overlay application is received at the receiver via the network interface.

9. The apparatus of claim 7, wherein the at least one overlay application is received at the receiver via the broadcast communications system.

10. The apparatus of claim 9, wherein the broadcast communications system is a satellite broadcast system.

11. The apparatus of claim 7, further comprising updating the overlay application when the overlay application is selectively displayed on the monitor.

12. The apparatus of claim 11, wherein updating the overlay application comprises streaming data to the overlay application.

13. The apparatus of claim 7, further comprising determining a location on the monitor for display of the overlay application via the user interface.

14. The apparatus of claim 7, further comprising creating a custom overlay application via the user interface.

15. A system for displaying a broadcast data stream and a user-selected overlay application on a monitor in a broadcast communications system, comprising:
a transmission system for transmitting a plurality of broadcast data streams and for transmitting and generating a plurality of overlay applications;
a receiver for receiving the plurality of broadcast data streams and the plurality of overlay applications;
an overlay application controller, coupled to the receiver, for executing the plurality of overlay applications; and
a user interface, coupled to the receiver, for selecting the user-selected overlay application from the plurality of overlay applications, wherein the user-selected overlay application is displayed on the monitor simultaneously with the broadcast data stream.

16. The system of claim 15, further comprising a network interface, coupled to the receiver, wherein the network interface further receives the plurality of overlay applications from the transmission system.

17. The system of claim 16, further comprising a memory, coupled to the receiver and the network interface, wherein the user-selected overlay application is stored in the memory.

18. The system of claim 17, wherein the transmission system is a satellite broadcast system.

19. The system of claim 18, wherein the user-selected overlay application is customized via the user interface.

20. The system of claim 19, wherein the user-selected overlay application is created via the user interface.
